(19) United States
(12) Patent Application Publication
(10) Pub. No.: US 2003/0161601 A1
(43) Pub. Date: Aug. 28, 2003

(54) Thin film coating process and thin film coated optical components

(76) Inventors: Mike X. Ouyang, Painted Post, NY (US); Stephanus J. Spammer, Painted Post, NY (US)

Correspondence Address: VOLENTINE FRANCOS, PLLC, SUITE 150, 12200 SUNRISE VALLEY DRIVE, RESTON, VA, 20191, US

(21) Appl. No.: 10/087,235

(22) Filed: Feb. 28, 2002

(51) Int. Cl. G02B 6/22; B05D 5/06

(52) U.S. Cl. 385/128; 385/10; 427/162; 427/163.2

(57) ABSTRACT

In accordance with an exemplary embodiment of the present invention, a method of forming at least one layer over an optical element includes providing the optical fiber which has a central axis; rotating the optical element about the central axis; and forming the layer with a substantially uniform thickness during the rotation.

According to another exemplary embodiment of the present invention, an optical element has at least one layer of a substantially uniform radial thickness.

### FIELD OF THE INVENTION

The present invention relates generally to photonics, and particularly to a process for coating thin films, and thin-film coated optical components.

### BACKGROUND OF THE INVENTION

Optical communication systems, including optical fiber communication systems, have become a useful vehicle for carrying voice and data at high-speeds. Optical fibers have been developed and improved, and specialty fibers are often used to achieve a particular desired result in the optical fiber communication system.

One type of specialty optical fiber, a fiber Bragg grating, is often coated with a metal to enable chromatic dispersion (CD) compensation. Chromatic dispersion results from the fact that in transmission media, such as glass optical fibers, the higher the frequency of the optical signal, the greater the effective refractive index. As such, higher frequency components of an optical signal will “slow down,” and contrastingly, lower frequency components will “speed up.”

As is well-known, fiber Bragg gratings (FBG) are used to compensate for chromatic dispersion. Moreover, fiber Bragg gratings may be tuned by changing the resonant wavelength of the FBG. Typically, this alteration of the resonant wavelength of the grating is by elasto-optic or thermo-optic effects. The elesto-optic tuning is usually effected by applying a strain to the grating. Illustratively, this strain results in a Bragg wavelength shift of approximately 1 pm/microStrain. Using thermo-optic tuning, the wavelength shift is illustratively approximately 10 pm/° C.

It is often useful to coat optical fiber with a material to achieve a desired benefit. For example, coatings applied to the buffer layer of the optical fiber to achieve a variety of results. The type of coating chosen depends upon the function the coating is to achieve. Illustrative types of coatings include metals, dielectrics, piezoelectric materials, and other coatings which provide a certain function to the optical fiber. Illustratively, a piezoelectric coating of materials such as zinc oxide (ZnO) may be used for optical fiber acousto-optic phase modulation and actuation.

A metal coating is useful on the CD compensating optical fiber to protect the fiber from long term strains and stresses associated with elasto-optic tuning. Moreover, the metal coating may be used to effect thermal tuning of the FBG. To wit, temperature tuning of the Bragg wavelength is usefully effected by techniques which result in low-power consumption. Typically, this is carried out through the use of thin-film heaters directly deposited onto the optical fiber. By running a current through the metal coating on the fiber, the fiber is heated in a controlled manner and the Bragg wavelength is controllably altered.

As can be appreciated, a metallized FBG can be used in a variety of applications. These illustratively include integrated tunable fiber Bragg gratings for dispersion compensation; tunable optical filter and tunable fiber laser applications; programmable add/drop filters; variable attenuators; and optical fiber polarizers. As such, the use of metal coatings on fiber Bragg gratings has garnered a significant amount of attention in the optical communication industry.

Unfortunately, while the various types of coatings applied to optical fibers have been useful in achieving certain desired results such as those described above, coating induced birefringence can result in polarization mode dispersion (PMD) which can be particularly problematic. To wit, PMD can adversely impact the signal quality of an optical communication system. Polarization mode dispersion is a fundamental property of single mode optical fiber and components in which signal energy at a given wavelength is resolved into two orthogonal polarization states of slightly different propagation velocity. The resulting difference in the propagation time between these states of polarization is called the differential group delay, which can have deleterious effects on the quality of the optical signal.

In digital optical communication systems, where the optical signal is ideally a square-wave, PMD may cause optical pulse spreading, or pulse deformation in general. The spreading of the digital pulse in time may cause it to overflow into the time slot which has been allotted to another bit. Ultimately, the individual bits are difficult to distinguish, and inter-symbol interference (ISI) may occur. ISI may result in an increase in the bit-error rate (BER) to unacceptable levels.

A primary source of coating induced birefringence and, thereby PMD, is variation in coating thickness around the optical fiber and along the optical fiber to which a coating has been applied. As a result of coating thickness variation around and along the optical fiber, stress induced and thermal induced birefringence can be unacceptably high. For example, in an FBG, the stress and thermal induced birefringence can result in PMD that is increased four-fold to ten-fold after the coating is applied, depending upon the thickness and method of coating.

As can be appreciated, while various types of coatings are beneficial in a variety of optical fiber applications, there are clear drawbacks to conventional coatings, conventional coated fibers, and the method of application of the coating(s). Accordingly, what is needed, therefore, a method of forming a coating over an optical element, and the resultant element which overcomes at least the drawbacks described above.

### SUMMARY OF THE INVENTION

In accordance with an exemplary embodiment of the present invention, a method of forming at least one layer over an optical element includes providing the optical fiber which has a central axis; rotating the optical element about the central axis; and forming the layer with a substantially uniform thickness during the rotation.

According to another exemplary embodiment of the present invention, an optical element has at least one layer of a substantially uniform radial thickness.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1(a) is side view of a fiber coating apparatus in accordance with an exemplary embodiment of the present invention.

FIG. 1 (b) is an exploded view of a rotation apparatus and carrier frame in accordance with the exemplary embodiment of the present invention shown in FIG. 1(a).

FIG. 2 is a perspective view of a fiber coating apparatus in accordance with an exemplary embodiment of the present invention.

FIG. 3 is a cross-sectional view of a fiber coating apparatus in accordance with the exemplary embodiment shown in FIG. 2, taken along line 3-3.

FIG. 4 is a graphical representation of the coating thickness on an optical fiber versus heating power along the optical fiber in accordance with an exemplary embodiment of the present invention.

FIG. 5 is a top view of a shadow mask for use with a fiber coating apparatus in accordance with an exemplary embodiment of the present invention.

FIG. 6 is top view of a shadow mask for use in a fiber coating apparatus in accordance with another exemplary embodiment of the present invention.

FIG. 7 is a tabular representation of various metal films coated on optical fibers used for thin film heater elements and sensor elements in accordance with an exemplary embodiment of the present invention.

FIG. 8 is a graphical representation of the temperature dependence of the resistance of a thin film resistor on an optical fiber in accordance with an exemplary embodiment of the present invention.

FIG. 9 is a perspective view of a process sequence of a deposition process in accordance with an exemplary embodiment of the present invention.

FIG. 10 is a perspective view of a fiber coating apparatus in accordance with another exemplary embodiment of the present invention.

FIG. 11(a) is a top view of a carrier for use in an electron-beam deposition chamber for coating optical fibers in accordance with an exemplary embodiment of the present invention.

FIG. 11 (b) is a perspective view of an electron-beam deposition chamber for coating optical fibers in accordance with the exemplary embodiment of the present invention shown in FIG. 11(a).

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to a method and apparatus for uniformly coating optical elements, and optical devices having uniform coatings. Illustratively, the uniformity of the coating is achieved in the radial direction.

In accordance with an exemplary embodiment of the present invention, the uniform coating in the radial direction is applied to optical fibers. Optical signals traversing optical fibers in accordance with the presently described embodiment experience polarization mode dispersion which is no greater than the polarization mode dispersion of an uncoated optical fiber. Illustratively, the optical fibers may have Bragg gratings written therein, and chromatic dispersion may be compensated in an optical fiber having such a Bragg grating, but without the increased polarization mode dispersion which plagues conventional coated optical fibers.

In accordance with the above described embodiment as well as other exemplary embodiments of the present invention, the coating material may be metal, metal-alloys, and piezoelectric materials, semiconductors, dielectrics as well as others both mentioned herein, and still other materials within the purview of the artisan of ordinary skill who has had the benefit of review of the present disclosure. Moreover, the coating may be multiple layers of such materials. The coatings are illustratively sputter deposited by physical vapor deposition (PVD).

It is noted that while the description which follows illustrates the use of the present invention on optical fibers and coated optic fibers, other optical elements may benefit from the coating process of the present invention. For example, elements may be hermetically sealed through the use of the present invention. Still other optical elements that are within the purview of one of ordinary skill in the art having had the benefit of review of the present disclosure may benefit from the coating process of the present invention. Usefully, any element coated by the method of the present invention has a central axis so that rotation thereabout enables a uniform material coating.

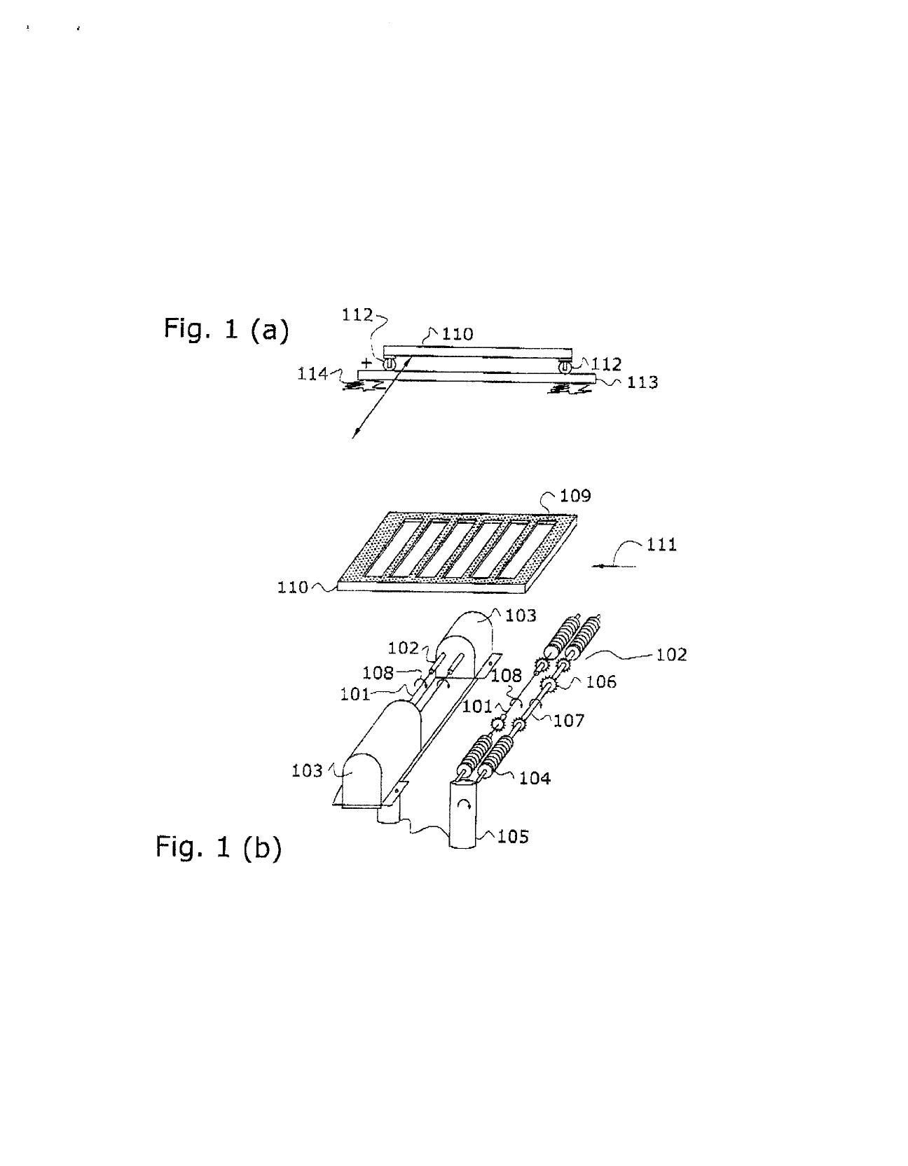

FIGS. 1(a) and 1(b) show an apparatus for applying coatings to optical fibers in accordance with an exemplary embodiment of the present invention. FIG. 1(a) is a side view of the apparatus, and FIG. 1(b) is an exploded view of the apparatus. In the exemplary embodiment of FIGS. 1(a) and 1(b), fiber Bragg gratings 101 are disposed in rotation mechanisms 102. One of the rotation mechanisms 102 is shown with metal covers 103 disposed over pigtail holders 104. Of course, the metal covers 103 of the other rotation mechanism 102 have been removed for purposes of illustrating the various elements which are normally covered by the metal cover 103. To wit, direct current (DC) motors 105 are used to effect the rotation of gears 106 and a rotation shaft 107.

In the exemplary embodiment shown in FIG. 1(b), the optical fibers 101 are fiber Bragg gratings, and are rotated about their central/optic axis (not shown) and in the clockwise direction 108. Of course, this is merely illustrative, and the rotation could be effected in a counter-clockwise manner.

Each of the rotation mechanisms 102 is disposed in a slot 109 in a carrier 110. The carrier 110 is illustratively driven by a chain, ferro-fluidics feedthrough (neither of which are shown in FIG. 1) or other device. The carrier 110 moves in a linear direction 111. The speed of the linear motion in the x-direction, any change in the speed, as well as the direction of the motion, and dwell time at a particular position is illustratively controlled by a micro-computer (not shown).

The fiber Bragg gratings 101 begin rotation when either of the wheels 112 come into electrical contact with the positive electrodes 113 which are supported by springs 114. In the exemplary embodiment shown in FIGS. 1(a) and 1(b), the carrier 110, in which the rotation mechanisms 102 are disposed, is maintained at a negative voltage. Upon the electrical contact with the positive potential, the DC motors 105 are powered. To wit, the DC motors 105 are illustratively shunt connected via the wheels 112 which are in contact with the positive voltage; and are shunt connected to the negative voltage via contact with the carrier 110. The DC motors 105 rotate the gears 106, and rotation shaft 107. This rotation will cease when electrical contact is interrupted between the wheels 112 and the electrode 113. It is further noted that the rotation speed of the rotation mechanisms 102 is carefully controlled through control of the voltage applied to the positive electrode 113. The positive electrode 113 is supported by springs 114, which keeps a minimum force on the carrier 110, and good electrical contact with the wheels 112.

As will become more clear as the present description continues, each rotation mechanism may hold a plurality of optical fibers. Moreover, the thickness of any coating applied to optical fibers 101 in the presently described illustrative embodiment is controlled by the sputter power, target-to-fiber distance, scanning speed, and the number of scans.

The thickness uniformity in the linear direction may be controlled by the target configuration and size. To this end, in accordance with an exemplary embodiment of the present invention, sputtered and evaporated materials leave the source (target or crucible) based on a cosⁿ(x) law, where x is the distance from the plane of the source. Magnetron sputtering using a planar source and the rate of the material leaving the target is different from position to position depending on the magnetron design. For example, a 15″×15″ planar target can cover a uniform diposition region of 12″×12″ (to 5%-10% variation if there is no substrate location). Using such targets uniform coatings on 16 cm non-linearly chirped fiber Bragg gratings illustratively were deposited.

In the exemplary embodiment shown in FIGS. 1(a) and 1(b), the carrier 110 may hold a plurality of rotation mechanisms, with one rotation mechanism 102 disposed in each slot 109 of the carrier 110. Each rotation mechanism illustratively includes two optical fibers, the rotation of which are driven by low voltage DC motors 105 through shaft and gear combinations. The rotation on both sides of each rotation mechanism 102 is synchronized, thereby enabling each module to rotate the fibers disposed therein at a particular speed without twisting the optical fiber. By avoiding the twisting of the fiber, torsion-induced birefringence, which plagues conventional methods and devices, is substantially avoided.

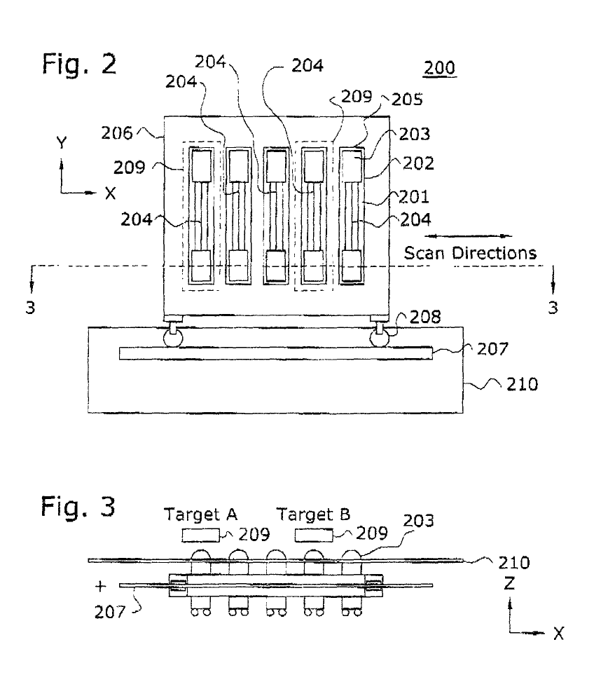

FIG. 2 shows an apparatus for coating an optical fiber in accordance with an exemplary embodiment of the present invention. The apparatus shown in FIG. 2 is substantially identical to the apparatus of the exemplary embodiment shown in FIG. 1(a), and includes the various elements shown in FIG. 1(b). As such, repetitive details previously described in connection with the exemplary embodiments of FIGS. 1(a) and 1(b) are omitted in the interest of brevity. Moreover, it is noted that FIG. 3 is a cross-sectional view taken along lines 3-3 of FIG. 2.

The apparatus 200 for coating an optical fiber includes a plurality of optical fibers 201 disposed in a plurality of rotation mechanisms 202 which illustratively include metal covers 203. Each of the rotation mechanisms 202 include a shaft 204. In addition, each of the rotation mechanisms 202 is disposed in a respective slot 205 in the carrier 206. The carrier 206 is maintained at a negative potential relative to the positive electrode 207. Moreover, DC motors (not shown) are shunt connected to the positive voltage of electrode 207 via wheels 208 as previously described.

In the present exemplary embodiment, a plurality of targets 209 are mounted in the PVD chamber, and are maintained at a negative potential. Thereafter, sputter deposition, a technique well known to one of ordinary skill in the art, may be carried out to effect the coating of the optical fibers 201 which undergo rotational and translational (in this case x-direction) motion during the deposition process. Further details of sputter deposition may be found in VLSI Fabrication Principles, 2^{nd} Edition pp. 514-517, by Soreb Ghandi. The disclosure of the above-captioned portion of the reference to Ghandi is specifically incorporated by reference herein. Moreover, other sputter techniques may be used to carry out the deposition of the layer(s) on optical fibers 201. To this end, for purposes of illustration and not limitation, it is noted that the apparatus of the exemplary embodiment works for any fixed and in-line sputtering system. It can also be used for electron beam deposition.

In the exemplary embodiment shown in FIG. 3, using a commercially available sputtering machine, the optical fibers 201 are rotated at a speed which is illustratively greater than approximately 60 revolutions per minute, depending upon the speed of the scan. Targets 209 in the exemplary embodiment is illustratively maintained at a distance of approximately 2.0″ to approximately 5.0″ from the fibers 201; the d.c. power supplied is 700W; and approximately the rotation speed is approximately 100 rpm to approximately 200 rpm. It is noted that the higher the deposition rate, the higher the stress and temperature generated birefringence. Accordingly, a relatively high rotation speed is employed to account for this. Moreover, a metal mask 210 is illustratively used to prevent the motor-driving electrode from being coated by insulating materials.

As described previously, the control of the thickness of the particular coating along the optical fiber, as well as the uniformity thereof is particularly beneficial. The rotational sputter deposition technique of the present exemplary embodiment enables single and multiple-layer metal coatings having a thickness of approximately 0.1 μm to approximately 100 μm and with a uniformity of approximately 95% to approximately 99.99%.

For purposes of illustration and not limitation, it is noted that the following materials may be used for particular purposes described therewith.

Heating and temperature sensing coating materials illustratively include Pt, Au, include Ni:Cr. Moreover, it is noted that when a metal layer is formed on a fiber, it may be useful to provide a Cu:Ga underlayer to enhance the strength of the fiber and to reduce polarization mode dispersion in a signal traversing the fiber.

Adhesion enhancement coating materials illustratively include Cr, Cr₂O₃, Al₂O₃, Ti, and Si₃N₄. Packaging coating materials illustratively include Al, Au, Au:Sn, and Cu:Ga.

Dielectric coatings to isolate electrodes illustratively include SiO₂, Si₃N₄, Al₂O₃, SiNO, and Cr₂O₃.

Piezoelectric coatings illustratively include ZnO, AlN, PZT, PLZT, and LiNbo₃. Finally, it is noted that other thin film function coatings including semiconductors, such as Si, GaAs, a-Si:H, InAs, InGaAs, GaN, and GaAs; magnetostrictive materials, such as Fe:B, Sm:Fe, and Fe:Si:B alloys, can be deposited in accordance with exemplary embodiments of the present invention to meet certain desired ends.

In the exemplary embodiment in which metal coatings are applied to chirped FBG's, the metal film thickness distribution along the fiber may be particularly beneficial in a variety of applications. As is well known, the chirp may be linear which means the period of grating varies linearly with the length of the grating. Moreover, the grating may be nonlinearly chirped, illustratively quadratic or even period selective. As is well known, chirped fiber Bragg gratings may be used for chromatic dispersion compensation in optical systems; in add/drop multiplexor (ADM) transmission systems; gain switch semiconductor lasers; sensors; amplified stimulated emission (ASE) suppression; amplifier gain flattening; and band blocking and band-pass filtration. By applying a metal/alloy coating to the chirped FBG, the spectral line width, center wavelength and the compensation of chromatic dispersion can be adjusted by changing the thermal distribution the chirped FBG.

In accordance with exemplary embodiments of the present invention, uniformity of the coating(s) applied to the fiber means the coatings are radially symmetric. Of course, this radial symmetry results in the thickness of the layer having a dependence on the radius. In order to effect the formation of a coating having radial symmetry (i.e. uniformity) but with a radial dependence, shadow masks may be used during sputtering. As will become more clear as the present description proceeds, it may be beneficial, for example, to choose a particular coating profile to exact a particular resistance profile over the coating length of fiber. To this end, and in accordance with another exemplary embodiment of the present invention, the control of the thickness distribution of the coating on an optical fiber can be achieved by maintaining the position of the optical fiber(s) under the sputter gun, and maintaining the rotation while scanning a shadow mask between the optical fibers and the sputter gun.

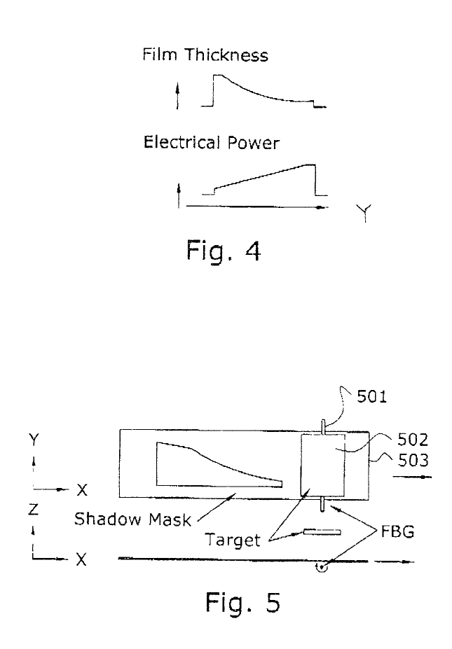

FIG. 4 is a graphical representation showing the coating thickness on an optical fiber versus heating power along the optical fiber. In the present exemplary embodiment, the optical fiber is a fiber Bragg grating. From FIG. 4, it can be seen that the resistance is a function of the thickness of the metal film and the electrical heating power, which is proportional to I²ΔR (where I is the current through the film heater, and AR is the resistance in a small section of the fiber Bragg grating) is impacted by the resistance. By selecting the opening shape of a particular shadow mask, and the motion speed variation, a specific thickness profile may be achieved. It is noted, of course, that regardless of the profile selected, the coating is radially symmetric, and therefore uniform within the meaning of the present invention.

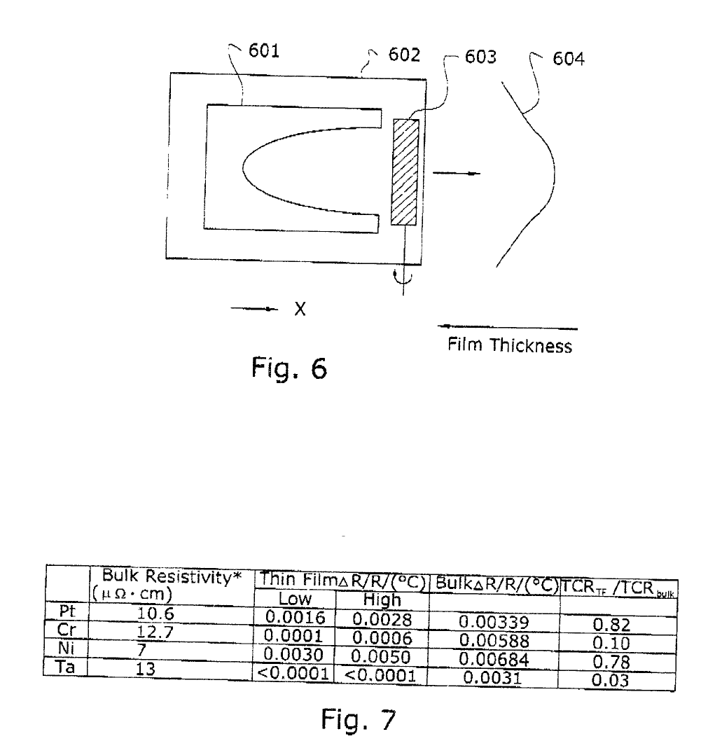

FIGS. 5 and 6 show shadow masks and metal film thickness distributions in accordance with exemplary embodiments of the present invention. It is noted that in the descriptions of FIGS. 5 and 6, one optical fiber is isolated for ease of discussion, and, of course, application of a shadow mask to a structure such as shown in FIG. 2 would result in the exemplary thickness distributions across all fibers.

In the exemplary embodiment shown in FIG. 5, an optical fiber 501 has a target 502 disposed thereover. A shadow mask 503 is disposed between the optical fiber 501 and the shadow mask 502. Motion of the shadow mask is in the x-direction. The resulting film thickness distribution is shown in FIG. 4. In the present exemplary embodiment, changing the shape of opening and the scan speed enables any thickness profile along the fiber can be achieved. (It is noted that the distribution in FIG. 4 is an example of this effect).

Similarly, as shown in FIG. 6, a shadow mask 601 is disposed between an optical fiber 602 and a target 603. Sputter deposition using the apparatus and techniques described in connection with the exemplary embodiments above result in a thickness distribution shown in curve 604. If the planar sputtering target has an uniform film distribution in this region and the scan speed is linear, the shape of the opening in the shadow mask 601 is replicated in the thickness profile along the fiber. If the scan speed is not linear (e.g., it is programmable), the profile can be changed according to the scan profile. Generally, the static uniformity is not 100%.

FIG. 7 is a table of various metals and data for these metal when coated on optical fibers. For heater applications, resistivity and the coating length determine the thickness range in which electronic drivers can be employed effectively. The temperature coefficient of resistance (TCR) is an important parameter for sensor applications. Both resisitivity and TCR of a certain metal film will be different from its bulk counterparts depending on the thickness, density and the deposition process used.

A thin film resistor with the thickness d, the length L and the width W has the total resistance of

$$R = \frac{L}{Wd} ρ = \frac{L}{W} \frac{ρ}{d} = \frac{L}{W} {R}_{s} \qquad eqn . ( 1 )$$

where R_{S} is called the sheet resistance in the unit of (Ωsquare), which is the resistance of a square resistor and can be measured by using a four point probe.

The temperature coefficient of resistance (TCR) of metals is expressed as:

$$TCR = \frac{1}{{ρ}_{0}} \frac{ⅆ R}{ⅆ T} \approx \frac{1}{{ρ}_{0}} \frac{Δ R}{Δ T} \qquad eqn . ( 2 )$$

where ρₒ is the resistivity at 0° C. and T is the temperature. Metal has positive TCR because that the electron scattering by phonons, point defect and structure imperfection in metal films. However, in the very thin film regime, some metal system has a negative TCR because of tunneling effects. Both the sheet resistance and the TCR of a thin metallic films depend on material, thickness, deposition method, deposition condition and post-deposition treatment method. It is noted that FIG. 7 lists TCRs of the thermal evaporated resistivities and their bulk counterparts. The difference between the thin film and the bulk properties is due to the difference in density, structure, and the purity.

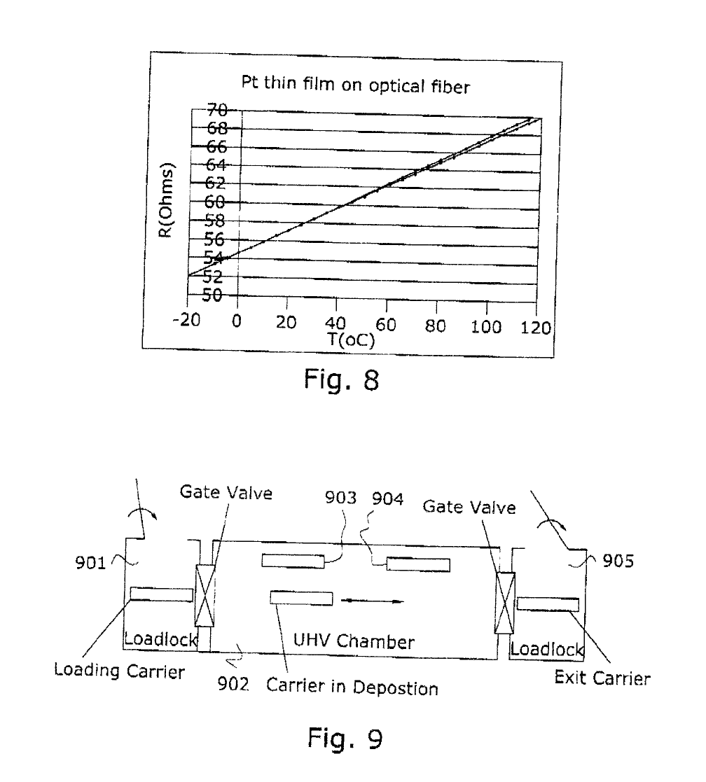

It is noted that the minimum thickness of a coating of a particular area, the area coated, and the heat dissipation packaging should be considered when designing a thin film heater for a given power rating in order to minimize deterioration of the heater. In the exemplary embodiment shown in FIG. 8, the resistance versus temperature relationship of a 4 cm fiber Bragg grating coated with platinum is shown. Advantageously, to enhance adhesion, a thin layer of CrOₓ or Cr/Cr₂O₃ film may be applied to the FBG prior to coating with platinum.

The CrOₓ coating is deposited by reactive sputtering using a mixture of Argon and Oxygen. Then by changing the gas completely to Argon and applying power on a different gun with the platinum target, the platinum coating may be deposited in the same chamber. The Pt film is useful for heating elements as well as sensor elements because of its stable resistivity to the environment and the linear and large TCR. A coating with a reasonable resistivity can sense a very small temperature change (less than 1° C.).

FIG. 9 is a perspective view of a process sequence for continuous FBG metalization in accordance with an exemplary embodiment of the present invention. The exemplary process flow sequence shown in FIG. 9 incorporates the various elements and processes described previously, for example in connection with FIGS. 1 and 2. The carrier (illustratively carrier 110 of FIG. 1) is disposed in a load lock 901. Thereafter, they enter the deposition chamber 902 which is illustratively a ultra high vacuum (UHV) chamber. Chromium targets 903 and platinum target 904 are used to effect the deposition of the adhesion layer and coating layer, respectively. Upon completion, the carrier with the coated fibers is introduced to an exit load lock 905.

In the exemplary sputter techniques described thus far, the length of fiber to which a uniform coating may be applied can be limited by the length of the sputter target (e.g., sputter target 904). For example, for optical fibers such as fiber Bragg gratings, which have a length greater than 25 cm, it is not practical to increase the size of the target to accommodate the length of the fiber. Accordingly, rather than coating the optical fiber via motion orthogonal to its optic axis, it may be beneficial to sputter deposit the coating using a coaxial-type-device.

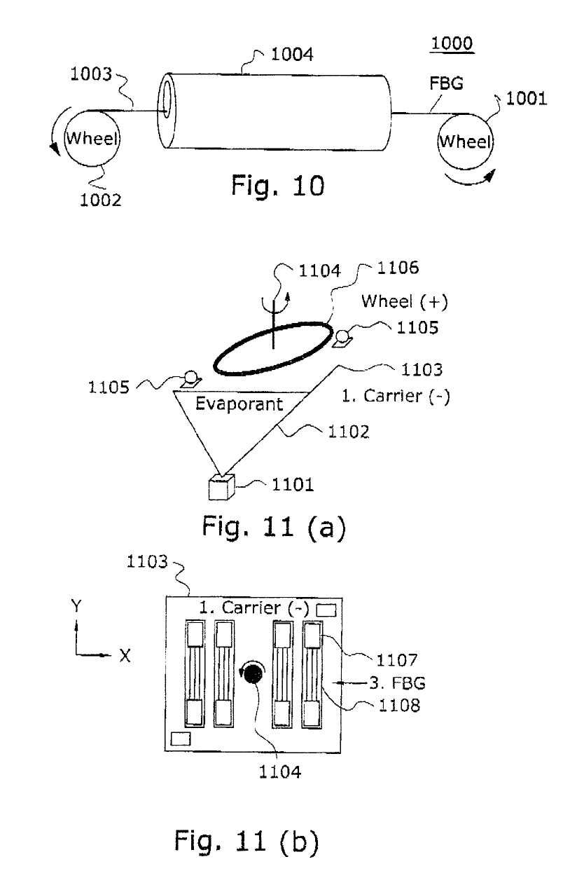

FIG. 10 shows a coaxial sputter deposition apparatus according to an exemplary embodiment of the present invention. The deposition apparatus 1000 may be used to coat optical fibers up to a meter in length. In the exemplary embodiment shown in FIG. 10, a first wheel 1001 and a second wheel 1002 cooperate to introduce optical fiber 1003 wound therearound into a cylindrical magnetron sputtering cathode 1004. Illustratively, a relatively small load (e.g., less than 200 grams) is required to prevent the optical fiber (illustratively a fiber Bragg grating) from breaking due to the brittleness of a polymer coating removed from a grating section to enable grating writing and to foster coating adhesion.

In accordance with the exemplary embodiment of the present invention shown in FIG. 10, sputter deposition which is very similar to that described in connection with the exemplary embodiments above may be carried out. Likewise, coatings may be applied to the optical fiber 1003 which are substantially radially symmetric. Moreover, in keeping with the exemplary embodiments described above, other materials besides metal may be deposited using the exemplary apparatus of FIG. 10. These include other materials referenced previously; as well as multiple layers thereof.

While sputter deposition has been described in the illustrative embodiments previously, other techniques for applying a uniform coating on an optical fiber may be used. One such technique is electron beam (e-beam) evaporation, which results in the deposition of a coating on the optical fiber. Electron beam evaporation is a technique well known to one of ordinary skill in the art, whereby an intense beam of energy is applied locally to a target, developing a sufficiently large flux of evaporant from refractory and nonrefractory materials. Further details of e-beam evaporation may be found in the above-referenced text by Soreb Ghandi, at pp. 511-514, the disclosure of which is specifically incorporated herein by reference.

FIG. 11(a) and 11(b) are perspective and top views, respectively, of an electron beam deposition apparatus in accordance with an exemplary embodiment of the present invention. An electron beam source 1101 creates an evaporant field 1102 which is incident upon the carrier 1103 in which optical fibers are disposed. A rotation shaft 1104 is disposed substantially through the center of the carrier 1103. Wheel elements 1105 and a wheel guide electrode 1106 usefully drive the DC motors of the rotation mechanisms 1107 in which the optical fibers 1108 are held. It is noted that the carrier 1103, as well as the rotation mechanisms 1107 are substantially identical to, and function substantially the same manner as described in conjunction with the exemplary embodiments above in which a sputter deposited coating is applied to an optical fiber. Moreover, the deposited materials, in kind and number, as well as the various types of fiber described previously are substantially identical.

It is noted that e-beam deposition techniques may use metals or non-metals as the source and energetic electrons as the heating source to evaporate the source material. The source is approximates a point source. The material emission still approximates a cosⁿ(r) law, where r is the distance from the source. The film thickness profile along the fiber may be controlled by the location relative to the source and the shadow mask shape. By rotating the fiber using fixtures described above in connection with exemplary embodiments, a very uniform coating can be made in radial direction to substantially avoid birefringent affects.

The polarization mode dispersion spectra of fiber Bragg gratings which have metal coatings disposed thereover in accordance with an exemplary embodiment of the present invention for thermal tuning of the grating to enable tunable compensation of chromatic dispersion in an optical signal has been compared to an FBG which has not been coated. In the presently described exemplary embodiment, the fiber Bragg gratings are illustratively a chirped fiber Bragg gratings having a length of approximately 10 cm. During fabrication, the chirped FBG was rotated at rate of approximately 120 RPM to approximately 150 RPM in the rotation mechanism (e.g., rotation mechanism 102), and the total resistance of the coating is approximately 50Ω on a 12 cm coated section of the chirped FBG. It is noted that Cr₂O₃ is one of the best adhesion enhancement layer between Pt and the glass of the fiber. Reactive sputtering is illustratively used in carrying out the coating of the fiber with Cr as target and Ar:O₂ as the active gas. The deposition rate and the Ar:O₂ ratio will determine the stoichiometry of chromium oxide. The composition may not be exactly Cr₂O₃. It may be CrOₓ, where x is in the range of greater than approximately 0 to approximately 1.5.

The first of two FBG's coated by the illustrative method described above has coatings of approximately of Pt. The second has an adhesion layer of Cr₂O₃ having a thickness of approximately 30 nm, and Pt layer having a thickness of approximately 1 μm is disposed thereover.

Notwithstanding a slight shift to a shorter wavelength due to compressive forces of the coating due to thermal expansion coefficient mismatch of the platinum coating and glass of the fiber, a substantially insignificant amount of polarization mode dispersion differential exists between the coated and uncoated layers. To wit, the coated fiber Bragg gratings according to an exemplary embodiment of the present invention exhibit an average polarization mode dispersion within a 1.8 nm bandwidth (illustratively in the range of approximately 1,552.5 nm to approximately 1554.3 nm) that is less than approximately 1 picosecond before and after being coating. As such, the coatings applied in accordance with the present invention as described in conjunction with exemplary embodiments herein exhibit substantially no greater PMD then uncoated fibers.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. A method of forming at least one layer, the method comprising:
providing at least one optical element having a central axis;
rotating said at least one optical element about said central axis; and
forming the at least one layer with a substantially uniform thickness during said rotation.

2. A method as recited in claim 1, wherein said at least one optical element is at least one optical fiber.

3. A method as recited in claim 2, wherein said at least one optical fiber is a fiber Bragg grating (FBG).

4. A method as recited in claim 1, wherein said at least one layer is chosen from the group consisting essentially of: metal, metal-alloys, non-metals, dielectrics, semiconductors, and piezoelectric materials.

5. A method as recited in claim 1, wherein one of said at least one layer is an adhesion layer.

6. A method as recited in claim 5, wherein said adhesion layer is chosen from the group consisting essentially of: Cr, Cr₂, O₃, Al₂O₃, Ti, and Si₃N₄.

7. A method as recited in claim 4, wherein said metals and said metal-alloys include Pt, Au and Ni:Cr.

8. A method as recited in claim 4, wherein said piezoelectric materials include ZnO, AlN, PZT, PLZT and LiNbO₃.

9. A method as recited in claim 1, wherein said substantially uniform thickness has radially uniformity in the range of approximately 95% to approximately 99%.

10. A method as recited in claim 1, wherein said substantially uniform thickness is in the range of approximately 1 μm to approximately 100 μm .

11. A method as recited in claim 3, wherein said FBG exhibits an average polarization mode dispersion of approximately 1 picosecond over a wavelength range of approximately 1552.5 nm to approximately 1554.3 nm.

12. A method as recited in claim 1, wherein said forming further includes depositing the at least one layer by physical vapor deposition.

13. A method as recited in claim 1, wherein said forming further comprises depositing the at least one layer by electron-beam deposition.

14. An optical element, comprising:
an at least one layer having a substantially radially uniform thickness disposed about the optical element.

15. An optical element as recited in claim 14, wherein said optical element is an optical fiber.

16. An optical element as recited in claim 14, wherein said at least one layer is chosen from the group consisting essentially of: metals, metal-alloys, non-metals, dielectrics, semiconductors, and piezoelectric materials.

17. An optical element as recited in claim 14, wherein one of said at least one layers is an adhesion layer.

18. An optical element as recited in claim 17, wherein said adhesion layer is chosen from the group consisting essentially of: Cr, Cr₂, O₃, Al₂O₃, Ti, and Si₃N₄.

19. An optical element as recited in claim 16, wherein said metals and metal-alloys include: Pt, Au and Ni:Cr.

20. An optical element as recited in claim 16, wherein said piezoelectric materials include: ZnO, AlN, PZT, PLZT and LiNbO₃.

21. An optical element as recited in claim 14, wherein said substantially uniform thickness has radial uniformity in the range of approximately 95% to approximately 99%.

22. An optical element as recited in claim 1, wherein said thickness is in the range of approximately 1 μm to approximately 100 μm.

23. An optical element as recited in claim 15, wherein said optical fiber is a fiber Bragg grating.

24. An apparatus, comprising:
rotation mechanism which rotates an optical element; and
a device which forms a coating of a substantially uniform thickness over said optical element during said rotation of said optical fiber.

25. An apparatus as recited in claim 24, wherein said rotation mechanism rotates said optical element about a central axis thereof.

26. An apparatus as recited in claim 24, wherein said optical element is an optical fiber.

27. An apparatus as recited in claim 24, wherein said optical fiber is a fiber Bragg grating (FBG).

28. An apparatus as recited in claim 24, wherein the apparatus further comprises a plurality of said rotation mechanisms, each of which rotate at least one of said optical elements.

29. An apparatus as recited in claim 24, wherein each of said rotational mechanisms is disposed in a respective opening in a carrier.

30. An apparatus as recited in claim 29, wherein said carrier moves translationally beneath said device.

31. An apparatus as recited in claim 24, wherein said device is physical vapor deposition device.

32. An apparatus as recited in claim 24, wherein said device is an electron beam deposition device.

33. An apparatus as recited in claim 28, wherein said optical element is an optical fiber.

34. An apparatus as recited in claim 33, wherein said optical fiber is a fiber Bragg grating (FBG).

35. An apparatus as recited in claim 24, wherein said thickness has a radially uniformity of approximately 95% to approximately 99%.
